(19) United States
(12) Patent Application Publication
(10) Pub. No.: US 2022/0097360 A1
(43) Pub. Date: Mar. 31, 2022

(54) PRINTHEAD HIGH SIDE SWITCH CONTROLS

(71) Applicant: Hewlett-Packard Development Company, L.P., Spring, TX (US)

(72) Inventors: Eric Thomas Martin, Corvallis, OR (US); Rogelio Cicili, San Diego, CA (US)

(73) Assignee: Hewlett-Packard Development Company, L.P., Spring, TX (US)

(21) Appl. No.: 17/311,430

(22) PCT Filed: Jun. 19, 2019
(86) PCT No.: PCT/US2019/037883

§ 371 Date: Jun. 7, 2021

(51) Int. Cl. B41J 2/045

(52) U.S. Cl. CPC B41J 2/04541; B41J 2/0455; B41J 2/0458

(57) ABSTRACT

In example implementations, an apparatus is provided. The apparatus includes a power supply, a first switch coupled to the power supply, a second switch coupled to the first switch, a third switch coupled to the power supply, the first switch, and the second switch, and a resistor coupled to the third switch. The first switch is to be controlled via a high voltage logic. The second switch is to be controlled via a low voltage logic. The resistor is to generate heat when energized. The first switch and the second switch are to control activation of the third switch to energize the resistor and cause a nozzle chamber to dispense a printing fluid.

### BACKGROUND

Printers are used to print images onto a print medium. Printers may print images using different types of printing fluids and/or materials. For example, some printers may use ink, toner, and the like. A print job may be transmitted to the printer and the printer may dispense the printing fluids and/or materials on the print medium in accordance with the print job.

### BRIEF DESCRIPTION OF THE DRAWINGS

FIG. 1 is a block diagram of a printer that is deployed with an example of the high side switch (HSS) control or circuit block of the present disclosure;

FIG. 2 is a block diagram of an example nozzle chamber that is controlled by the HSS control of the present disclosure;

FIG. 3 is a block diagram of an example HSS control of the present disclosure;

FIG. 4 is a circuit diagram of an example HSS control of the present disclosure;

FIG. 5 is an example of a plurality of primitives with a plurality of HSS controls of the present disclosure; and

FIG. 6 illustrates a flow chart of an example method to activate a thermal ink jet resistor using an HSS control of the present disclosure.

### DETAILED DESCRIPTION

Examples described herein provide a high side switch (HSS) control for a printhead. As discussed above, printers can use various types of systems and printing fluids to print images onto a print medium. One example can be a thermal ink jet (TIJ) printer that uses TIJ printheads. However, the present disclosure may apply to two-dimensional printers as well as three dimensional printers.

A TIJ printhead may include a nozzle chamber that includes a TIJ resistor that can generate heat when energized. The heat generated from the TIJ resistor may heat the printing fluid to create a steam bubble inside of the nozzle chamber that pushes the drop of printing fluid out of the nozzle chamber.

Different types of controls can be used to control activation of the TIJ resistor. Examples of the controls may include a low side switch (LSS) control and a high side switch (HSS) control. The LSS may provide a lower relative cost in terms of an amount of silicon area allocated to the circuits for controlling the LSS and the LSS itself. However, in some cases the LSS may provide no energy regulation against variation in power supply voltage, can have a reduced resistor life due to constant bias between the ink at ground and resistor at a voltage input, and the functionality of an entire group of resistors can be compromised if a single resistor shorts out.

In contrast, the HSS may provide solutions to the above issues with the LSS control. Namely, the HSS may provide energy regulation, some isolation to reduce the bias, and isolate damage to a single resistor if the resistor shorts out. However, the HSS uses a field effect transistor (FET) level shifter that may consume more silicon space, and it may therefore cost more to produce than the LSS. For example, the level shifter can consume as much as thousands of square microns of silicon area per nozzle.

In addition, some HSS control designs can use custom fabricated transistors or devices (e.g., non-industry standard devices). These custom devices can make it difficult to efficiently fabricate the HSS controls using standard circuit manufacturing processes in the integrated circuit industry.

Some HSS control designs may also use level shifters, which can draw hundreds of micro amps of current even when the nozzles are not firing. Multiplied by thousands of nozzles, the total amount of current that can be drawn in an idle state can be prohibitive.

The present disclosure provides a circuit design for the HSS control that reduces the amount of silicon that is used by simplifying the design of the HSS control. The simplified design reduces the number of high voltage p-type metal oxide semiconductor (HVPMOS) elements and changes the level shifter design to eliminate current that can be drawn when the nozzles are idle. In addition, the HSS control of the present disclosure eliminates the components associated with a clamp circuit. The clamp circuit can be included to protect susceptible devices from over-voltage events in the case of a fault or defect.

In addition, the HSS control of the present disclosure uses standard devices rather than custom devices. As a result, the circuit manufacturing processes to build the HSS control may be more available and cheaper to build. The overall amount of silicon that is used is reduced, thereby reducing the overall cost of producing the HSS control of the present disclosure.

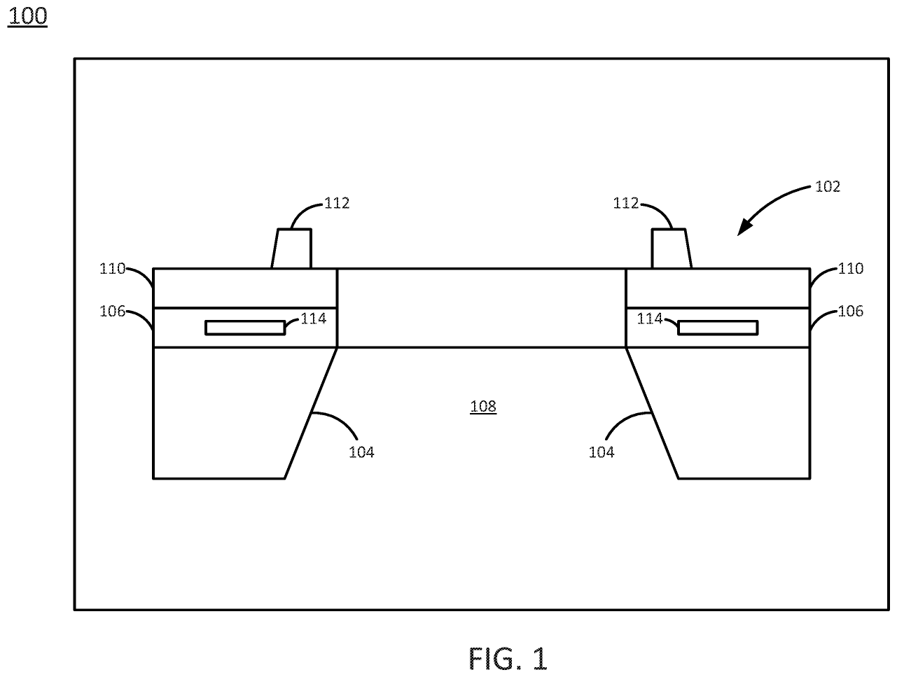

FIG. 1 illustrates an example printer 100 of the present disclosure. In one example, the printer 100 may be a thermal ink jet printer. The printer 100 has been simplified to show a cross-section of a fluidic die 102 used to eject printing fluid onto a print medium. The printer 100 may include additional components that are not shown, such as mechanical components associated with a print path, a feed module, a finishing module, a digital front end, a paper tray, reservoirs for the printing fluid, and the like.

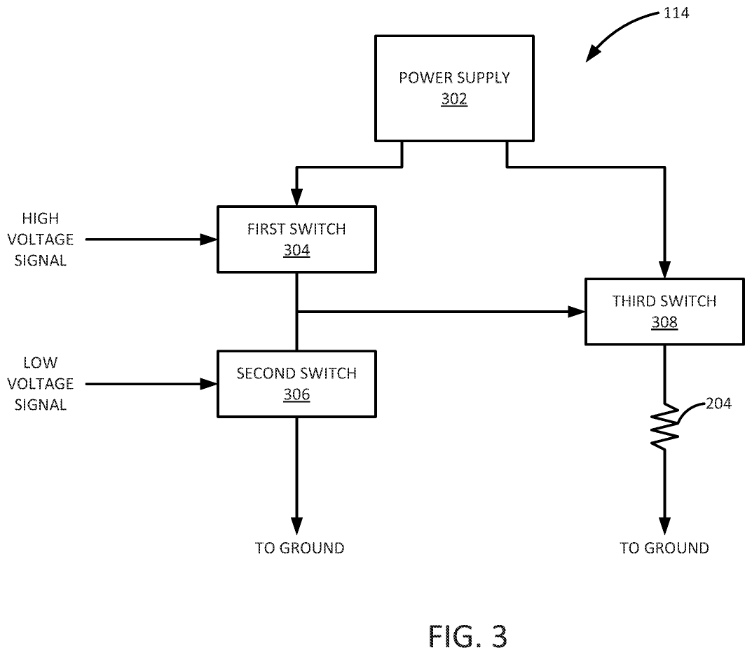

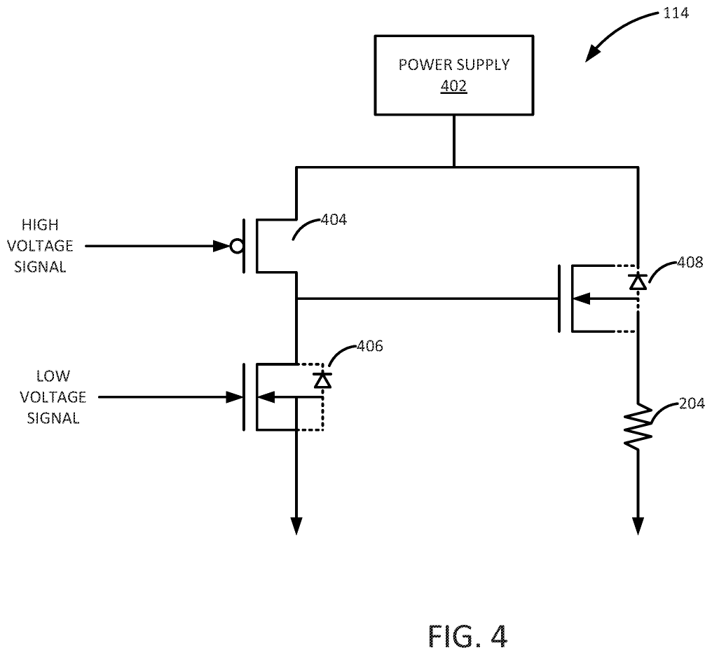

In one example, the fluidic die 102 includes a bulk silicon substrate 104. A layer of circuits 106 may be formed in and/or on the bulk silicon substrate 104. In one example, a high side switch (HSS) circuit block 114 of the present disclosure may be formed on the layer of circuits 106. The HSS circuit block 114 may be used to control the ejection of printing fluid from a nozzle 112 of the fluidic die 102. Each nozzle 112 may be associated with a respective HSS circuit block 114. In other words, the fluidic die 102 may include a plurality of HSS circuit blocks 114. The HSS 114 of the present disclosure is illustrated in FIGS. 3 and 4 and discussed in further details below.

In one example, the fluidic die 102 may include an ink slot 108 and a layer of fluidics 110. Printing fluid may move through the ink slot 108 to the desired nozzles 112 to be ejected onto a print medium.

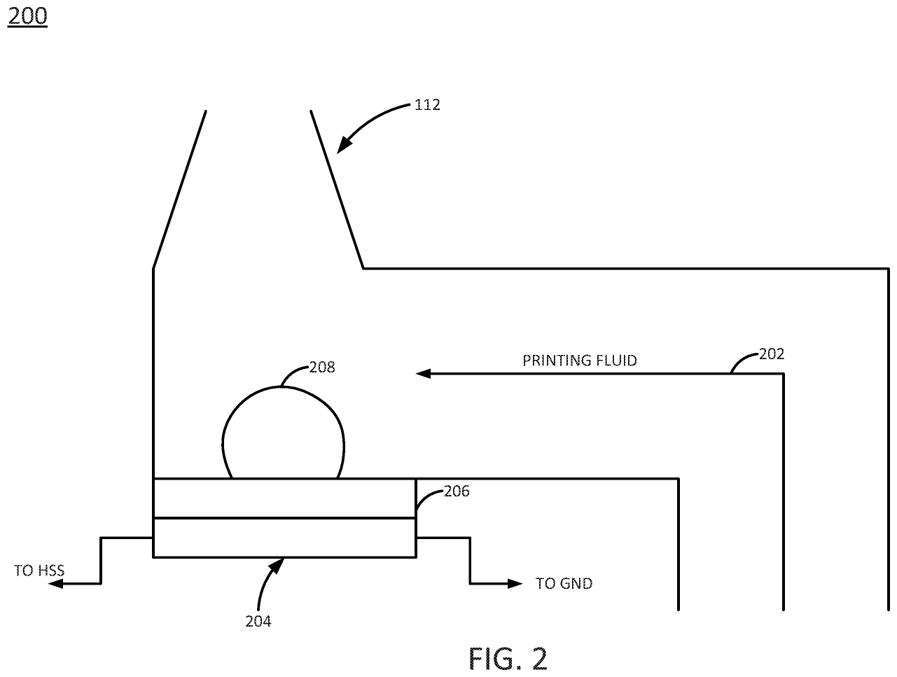

FIG. 2 illustrates a cross sectional view of an example nozzle chamber 200. Each nozzle 112 of the fluidic die 102 may be in fluid communication with a nozzle chamber 200. In one example, the nozzle chamber 200 may be coupled to the HSS 114. A portion of the nozzle chamber 200 may include a conductive plate 206. The conductive plate 206 may be made of a conductive metal (e.g., tantalum). The conductive plate 206 may be electrically isolated from other components in the nozzle chamber 200.

In one example, a resistor 204 may be positioned adjacent to the conductive plate 206 (also known as a cavitation plate). In one example, an oxide layer may be grown between the resistor 204 and the conductive plate 206. When a printing fluid 202 is provided into the nozzle chamber 200, the resistor 204 may generate heat when activated to form a steam bubble 208. The steam bubble 208 may force the printing fluid 202 out of the nozzle 112.

The conductive plate 206 may protect the underlying structures from the forces associated with the steam bubble 208 forming and collapsing in the nozzle chamber 200. The conductive plate 206 may also prevent the printing fluid 202 from contacting the resistor 204 and other electrically insulating layers. If the printing fluid 202 were to contact the resistor 204, a short would be formed, which may cause the nozzle chamber 200 to malfunction.

In one example, the HSS circuit block 114 of the present disclosure may be used to control activation of the resistor 204. As noted above, the HSS circuit block 114 of the present disclosure provides a circuit design that is smaller and consumes less silicon in the bulk silicon substrate 104. The design of the HSS circuit block 114 of the present disclosure does not include a circuit clamp and a test circuit, which can consume large amounts of the silicon in the bulk silicon substrate 104. The circuit clamp may be implemented in previous HSS controls to protect susceptible devices from over-voltage events in the case of a fault or defect.

Lastly, the design of the HSS circuit block 114 may use standard components that are not custom built, and therefore, more compatible with available manufacturing processes. As a result, the cost to build the HSS circuit block 114, and the overall fluidic die 102 may be significantly reduced.

Although an example of an ejecting actuator is illustrated in FIG. 2, it should be noted that the HSS circuit block 114 can also be used to control non-ejecting actuators (e.g., actuators that use micro-fluidic pumps). For example, the HSS 114 may be used to generate the steam bubble 208 that can be used to move fluid through a channel.

FIG. 3 illustrates a block diagram of an example of the HSS circuit block 114 of the present disclosure. In one example, the HSS circuit block 114 includes a power supply 302. The power supply 302 may provide high voltage. For example, the high voltage may be approximately greater than 10 volts. In one example, the high voltage may be approximately 30 volts.

A first switch 304 may be coupled to the power supply 302. The first switch 304 may be a high voltage switch and may operate via a high voltage signal. In one example, a high voltage switch may be a switch that can switch high voltage (e.g., 30 volts), but is controlled by a control signal that varies between a high voltage and a voltage threshold set by the low voltage signal. For example, if the high voltage is 30 volts and the low voltage signal is approximately 3.3 volts, then the high voltage switch may be controlled by a control signal that varies between 30 volts and approximately 27 volts.

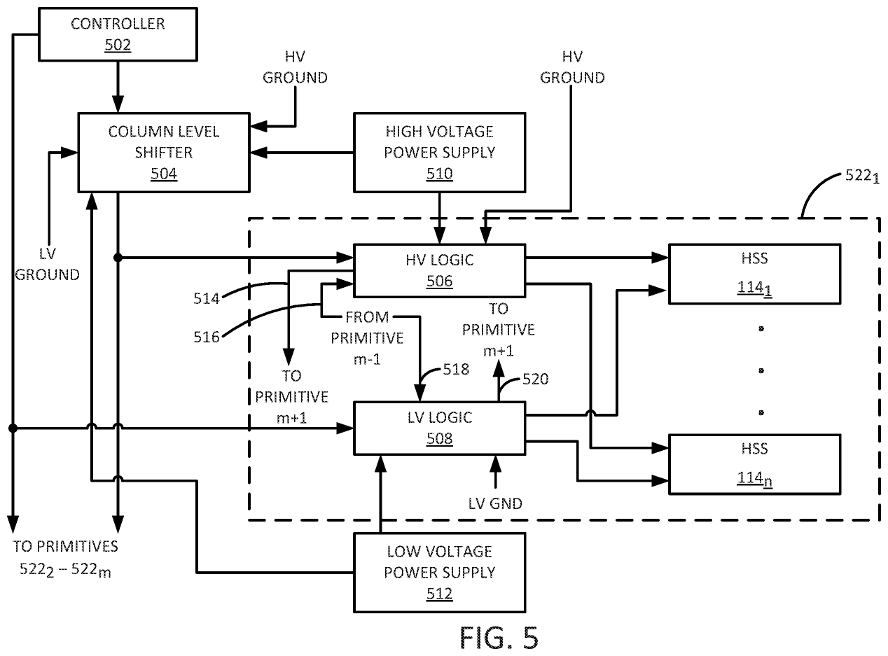

The high voltage signal may be a digital logic signal generated by a high-voltage control block, which is powered by a high-voltage power source, as illustrated in FIG. 5 and discussed in further details below. The gate of the first switch 304 may be controlled via a high voltage signal that varies between a high voltage and the high voltage less the low voltage signal. For example, if the low voltage signal is approximately 3.3 volts, the gate of the first switch 304 may be activated with a 27 volt signal or deactivated with a 30 volt signal.

In one example, a second switch 306 may be coupled downstream from the first switch 304. The second switch 306 may be a low voltage switch and may operate via a low voltage signal. In one example, a low voltage switch may be a switch that can switch high voltage (e.g., 30 volts), but is controlled with a low voltage signal. A low voltage signal may be a signal that switches between 0 and 5 volts or 0 and 3.3 volts.

The low voltage signal may be a digital logic signal generated by a low voltage control block, which is powered by a low voltage power source, as illustrated in FIG. 5 and discussed in further details below. The second switch 306 may be activated with a 3.3 volt signal and deactivated with a 0 volt signal.

In one example, a third switch 308 may be coupled to the power supply 302. The third switch 308 may be a low voltage switch that is tolerant of high voltage differentials. The third switch 308 may be coupled to the resistor 204. The resistor 204 may be the same resistor 204 illustrated in FIG. 2 to generate heat and create the steam bubble 208 to eject the printing fluid 202 out of the nozzle 112.

Although a single power supply 302 is illustrated in FIG. 3, it should be noted that multiple power supplies 302 may be deployed to trade off different levels of voltage regulation for power and thermal efficiency. For example, the first switch 304 and the third switch 308 may be coupled to separate power supplies 302.

In one example, the first switch 304 and the second switch 306 may operate in an inverse relationship to control activation of the third switch 308. For example, when the first switch 304 is activated, and the second switch 306 is deactivated, the third switch 308 may be activated to couple the output of the power supply 302 to the resistor 204. When the third switch 308 is activated, the current may flow through the third switch 308 and to the resistor 204. The current flowing through the resistor 204 may cause the resistor 204 to generate heat, form the steam bubble 208, and eject the printing fluid 202, as described above.

In one example, when the first switch 304 is deactivated and the second switch 306 is activated, the third switch 308 may be deactivated. In other words, the third switch 308 may decouple the power supply 302 from the resistor 204. As a result, no current flows through the third switch 308 to the resistor 204, which turns off the resistor 204.

Notably, the HSS circuit block 114 of the present disclosure uses fewer high voltage switches of either NMOS or PMOS type compared to previous HSS designs. The high voltage switches may be larger and may consume more of the silicon die. Thus, by reducing the number of high voltage switches, the overall size of the HSS circuit block 114 may be smaller, may consume less silicon die, and may be cheaper to manufacture.

FIG. 4 illustrates a circuit diagram of an example of the HSS circuit block 114 of the present disclosure. In one example, the HSS circuit block 114 includes a power supply 402. The power supply 402 may provide high voltage. For example, the high voltage may be approximately greater than 10 volts. In one example, the high voltage may be approximately 30 volts. As noted above, although a single power supply 402 is illustrated in FIG. 4, two separate power supplies 402 may be implemented to provide power to the connected switches.

A high voltage p-type metal oxide semiconductor (HVPMOS) switch 404 may be coupled to the power supply 402. The HVPMOS switch 404 may be a high voltage switch that may be controlled via a high voltage signal. The high voltage signal may be a digital logic signal generated by a high voltage control block, which is powered by a high voltage power source, as illustrated in FIG. 5 and discussed in further details below. The gate of the HVPMOS switch 404 may operate between a high voltage and the high voltage less a low voltage signal. For example, if the low voltage signal is approximately 3.3 volts, the gate of the HVPMOS switch 404 may be activated with 27 volt signal or deactivated with a 30 volt signal.

In one example, a single gate laterally diffused metal oxide semiconductor (SGLDMOS) switch 406 may be coupled downstream from the HVPMOS switch 404. The SGLDMOS switch 406 may be a high voltage switch that is controlled via a low voltage signal. The low voltage signal may be a digital logic signal generated by a low-voltage control block, which is powered by a low voltage power source, as illustrated in FIG. 5 and discussed in further details below. The SGLDMOS switch 406 may be activated with a digital signal generated in response to a 3.3 volt signal and deactivated with a digital signal generated in response to a 0 volt signal.

In one example, a laterally diffused metal oxide semiconductor (LDMOS) switch 408 may be coupled to the power supply 402. The LDMOS switch 408 may be an n-type switch that is controlled via a high voltage signal (e.g., the gate of the switch 408 may transition between 0-30 V). The LDMOS switch 408 may be an efficient switch for controlling the heater resistor 204.

The heater resistor 204 may be coupled to the LDMOS switch 408. When the LDMOS switch 408 is activated, current may flow across the LDMOS switch 408 to the heater resistor 204. The heater resistor 204 may generate heat as current flows through the heater resistor 204 to create the steam bubble 208, which causes the printing fluid 202 to be ejected from the nozzle chamber 200.

In one example, the HVPMOS switch 404 and the SGLDMOS switch 406 may operate in an inverse relationship to control activation of the LDMOS switch 408. For example, when the HVPMOS switch 404 is activated, and the SGLDMOS switch 406 is deactivated, the LDMOS switch 408 may be activated to couple the output of the power supply 402 to the resistor 204. When the LDMOS switch 408 is activated, the current may flow through the LDMOS switch 408 and to the heater resistor 204. The current flowing through the heater resistor 204 may cause the heater resistor 204 to generate heat, form the steam bubble 208, and eject the printing fluid 202, as described above.

In one example, when the HVPMOS switch 404 is deactivated and the SGLDMOS switch 406 is activated, the LDMOS switch 408 may be deactivated. In other words, the LDMOS switch 408 may decouple the power supply 402 from the resistor 204. As a result, no current flows through the LDMOS switch 408 to the heater resistor 204, which turns off the heater resistor 204.

Notably, the HSS circuit block 114 of the present disclosure uses a single HVPMOS switch compared to previous HSS designs that use multiple HVPMOS switches. In addition, the HSS circuit block 114 of the present disclosure uses fewer high voltage switches of either NMOS or PMOS type compared to previous HSS designs. The HVPMOS switches may be larger and consume more of the silicon die. Thus, by reducing the number of HVPMOS switches, the overall size of the HSS circuit block 114 may be smaller, may consume less silicon die, and may be cheaper to manufacture.

FIG. 5 illustrates an example of a plurality of primitives 522 with a plurality of HSS circuit blocks (e.g., HSS circuit blocks 114₁₋ₙ) of the present disclosure. In one example, the fluidic die 102 may be organized into a plurality of primitives 522₁ to 522ₘ (hereinafter also referred to individually as a primitive 522 or collectively as primitives 522). Each primitive 522 may include a plurality of nozzle chambers 200 that are controlled by a respective HSS circuit block 114₁ to 114ₙ. HSS circuit blocks 114₁-114ₙ may each be implemented as illustrated in FIG. 3 or 4.

In one example, each primitive 522 may include a high voltage (HV) logic 506 and a low voltage (LV) logic 508. The HV logic 506 may be coupled to a high voltage power supply 510 and a high voltage ground (HV GND). The high voltage power supply 510 may provide 30 volts of power. The HV logic 506 may be a high voltage device that operates with high voltage provided by a high voltage power supply 510 and high voltage ground (HV GND). The HV logic 506 may generate a high voltage logic signal based on a high voltage signal received from a column level shifter 504. The high voltage signal generated by the HV logic 506 may be used to control the HSS control circuit 114. For example, the high voltage logic signal generated by the HV logic 506 may be sent to the gate of the first switch 304 or the HVPMOS switch 404 to toggle the gate.

The LV logic 508 may be a low voltage device that operates with low voltage provided by a low voltage power supply 512 and a low voltage ground (LV GND). The low voltage power supply 512 may provide 5 volts of power. The LV logic 508 may generate a low voltage logic signal based on a low voltage signal received from the column level shifter 504. The low voltage signal generated by the LV logic 508 may be used to control the HSS control circuit 114. For example, the low voltage logic signal generated by the LV logic 508 may be sent to the gate of the second switch 306 or the SGLDMOS switch 406 to toggle the gate.

In one example, the HV logic 506 may be communicatively coupled to HV logic 506 of other primitives 522. For example, the HV logic 506 may include a communication path 514 to the next primitive (e.g., primitive m+1) and a communication path 516 from the previous primitive (e.g., primitive m−1). Notably, the HV logic 508 in the first primitive 522₁ may not have the communication path 516 and the HV logic 506 in the last primitive 522ₘ may not have the communication path 514.

In one example, the LV logic 508 may be communicatively coupled to the LV logic 508 of the other primitives 522. For example, the LV logic 508 may include a communication path 518 to the next primitive (e.g., primitive m+1) and a communication path 520 from the previous primitive (e.g., primitive m−1). Notably, the LV logic 508 in the first primitive 522₁ may not have the communication path 518 and the LV logic 508 in the last primitive 522ₘ may not have the communication path 520.

In one example, the primitives 522 may each be coupled to the column level shifter 504 that is controlled by a controller 502. The controller 502 may be a processor or an application specific integrated controller (ASIC) chip that operates with low voltage. The controller 502 may provide a low voltage signal to the column level shifter 504. The column level shifter 504 may take the low voltage signals and generate a high voltage version of the low voltage signals. For example, if there was a low voltage enable signal, the column level shifter 504 may generate a high voltage “copy” of the same low voltage enable signal. The low voltage signal from the controller 502 may be sent to the LV logic 508. The high voltage signal that is a copy of the low voltage signal from the column level shifter 504 may be sent to the HV logic 506.

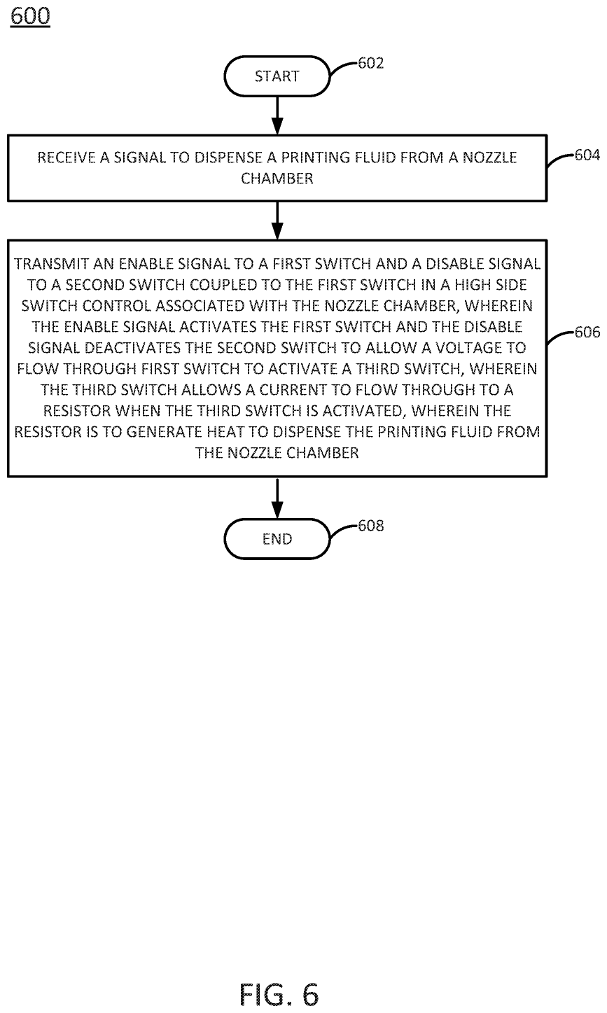

FIG. 6 illustrates a flow chart of an example method to activate a thermal ink jet resistor using an HSS control of the present disclosure. In an example, the method 600 may be performed by a controller or processor of the printer 100 illustrated in FIG. 1.

At block 602, the method 600 begins. At block 604, the method 600 receives a signal to dispense a printing fluid from a nozzle chamber. For example, a printer may be activated to print a desired image onto a print medium. A printer may determine locations on the print medium to dispense a printing fluid. The printing fluid may be dispensed via nozzle chambers in a fluidic die.

At block 606, the method 600 transmits an enable signal to a first switch and a disable signal to a second switch coupled to the first switch in a high side switch control associated with the nozzle chamber, wherein the enable signal activates the first switch and the disable signal deactivates the second switch to allow a voltage to flow through first switch to activate a third switch, wherein the third switch allows a current to flow through to a resistor when the third switch is activated, wherein the resistor is to generate heat to dispense the printing fluid from the nozzle chamber. For example, the printer may cause a high voltage logic to generate an enable signal to a control pin of the first switch to activate the gate of the first switch. The printer may also cause a low voltage logic to generate a disable signal to a control pin of the second switch to deactivate the gate of the second switch. When the first switch is activated, and the second switch is deactivated, the third switch may receive a high voltage (e.g., 30 volts) to the control pin of the third switch to activate the gate of the third switch.

When the third switch is activated, the current from the power supply may be allowed to flow through the resistor or the TIJ resistor. The current flowing through the resistor may cause the resistor to generate heat. The heat may cause a steam bubble to be formed inside of the nozzle chamber. The steam bubble may force the printing fluid through the nozzle and out of the nozzle chamber onto the print media.

In one example, a signal to stop the printing fluid from dispensing from the nozzle chamber may be received. For example, printing may be completed at a particular location of the print media for the print job.

In response to the signal to stop the printing fluid from dispensing, the printer may cause a disable signal to be transmitted to the first switch and an enable signal to be transmitted to the second switch. The disable signal may be sent to the control pin of the first switch to deactivate the gate of the first switch. The enable signal may be sent to the control pin of the second switch to activate the gate of the second switch. When the first switch is deactivated and the second switch is activated, the third switch may receive a low voltage (e.g., 0 volts) to the control pin of the third switch and deactivate the gate of the third switch. As a result, no current may flow through the third switch or the resistor. When no current flows through the resistor, the resistor may stop generating heat, which may eliminate the formation of the steam bubble, and prevent the printing fluid from being ejected out of the nozzle chamber. At block 608, the method 600 ends.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. An apparatus, comprising:
a power supply;
a first switch coupled to the power supply, wherein the first switch is to be controlled via a high voltage logic signal;
a second switch coupled to the first switch, wherein the second switch is to be controlled via a low voltage logic signal;
a third switch coupled to the power supply, the first switch, and the second switch; and
a resistor coupled to the third switch to generate heat when energized, wherein the first switch and the second switch are to control activation of the third switch to energize the resistor and cause a nozzle chamber to dispense a printing fluid.

2. The apparatus of claim 1, further comprising:
a controller; and
a column level shifter coupled to the controller to generate a high voltage signal copy of a low voltage signal to be provided by the controller.

3. The apparatus of claim 2, further comprising:
a high voltage logic coupled to the column level shifter; and
a low voltage logic coupled to the controller.

4. The apparatus of claim 3, wherein the high voltage logic is to provide the high voltage logic signal to the first switch.

5. The apparatus of claim 3, wherein the low voltage logic to provide the low voltage logic signal to the second switch.

6. The apparatus of claim 3, wherein the first switch, the second switch, the third switch, and the resistor are associated with a nozzle, wherein the high voltage logic, the low voltage logic and a plurality of nozzles are associated with a primitive.

7. The apparatus of claim 6, further comprising:
a plurality of primitives coupled to the column level shifter, wherein a respective high voltage logic and a respective low voltage logic of each one of the plurality of primitives are communicatively coupled.

8. The apparatus of claim 1, wherein the first switch and the second switch operate in an inverse relationship to control the activation of the third switch.

9. An apparatus, comprising:
a power supply;
a high voltage p-type metal oxide semiconductor (HVPMOS) switch coupled to the power supply, wherein the HVPMOS is to be controlled via a high voltage logic;
a first laterally diffused metal oxide semiconductor (LDMOS) switch coupled to the HVPMOS switch, wherein the LDMOS switch is to be controlled via a low voltage logic;
a second LDMOS switch coupled to the power supply, the HVPMOS switch and the first LDMOS switch; and
a resistor coupled to the second LDMOS switch to generate heat when energized, wherein the HVPMOS switch and the LDMOS switch are to control activation of the second LDMOS switch to energize the resistor and cause a nozzle chamber to dispense a printing fluid.

10. The apparatus of claim 9, wherein the first LDMOS switch and the second LDMOS switch are n-type devices.

11. The apparatus of claim 9, wherein the second LDMOS is activated to couple an output of the power supply to the resistor to allow a current to flow through the resistor in response to activation of the HVPMOS switch and deactivation of the first LDMOS switch.

12. The apparatus of claim 9, wherein the second LDMOS is deactivated to decouple an output of the power supply to the resistor to prevent a current from flowing through the resistor in response to deactivation of the HVPMOS switch and activation of the first LDMOS switch.

13. The apparatus of claim 9, wherein the power supply coupled to the HVPMOS switch and the second LDMOS switch are different power supplies.

14. A method comprising:
receiving, by a processor, a signal to dispense a printing fluid from a nozzle chamber; and
transmitting, by the processor, an enable signal to a first switch and a disable signal to a second switch coupled to the first switch in a high side switch control associated with the nozzle chamber, wherein the enable signal activates the first switch and the disable signal deactivates the second switch to allow a voltage to flow through first switch to activate a third switch, wherein the third switch allows a current to flow through to a resistor when the third switch is activated, wherein the resistor is to generate heat to dispense the printing fluid from the nozzle chamber.

15. The method of claim 14, further comprising:
receiving, by the processor, a signal to stop the printing fluid from dispensing from the nozzle chamber; and
transmitting, by the processor, a disable signal to the first switch and an enable signal to the second switch, wherein the disable signal deactivates the first switch and the enable signal activates the second switch to prevent the voltage from flowing through the first switch and to deactivate the third switch to prevent the current from flowing through the resistor.
